(19) United States
(12) Patent Application Publication
(10) Pub. No.: US 2005/0190658 A1
(43) Pub. Date: Sep. 1, 2005

(54) Magneto-optical recording medium, and method for fabricating the same

(75) Inventors: Tsutomu Tanaka, Kawasaki (JP); Ryo Kurita, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/116,230

(22) Filed: Apr. 28, 2005

Related U.S. Application Data
(63) Continuation of application No. PCT/JP02/11179, filed on Oct. 28, 2002.

(51) Int. Cl. G11B 11/00

(52) U.S. Cl. 369/13.55; 369/13.35

(57) ABSTRACT

This invention provides a magneto-optical recording medium forming method of laminating, on a substrate, three magnetic films having different compositions via at least a heat radiating layer, forming a dielectric film of a predetermined film thickness on the resulting structure, nitriding the magnetic films in an area where no information is to be recorded, and further laminating a material constituting the dielectric film on the resulting structure.

### TECHNICAL FIELD

This invention relates to a magneto-optical recording medium and a method for fabricating the same, and more particularly, to a magneto-optical recording medium in which shifting of domain walls is used to conduct reproduction and a method for fabricating the same.

### BACKGROUND ART

Hitherto, magneto-optical recording media onto which a light beam is radiated so as to record and reproduce information have been put into practical use. In order to improve the reproduction characteristics of high-density recording media, suggested is a magneto-optical recording medium having a reproduction system using shift of domain walls (for example, Japanese Unexamined Patent Publication No. HEI 6 (1994)-290496).

This document describes a magneto-optical recording medium having three successively-laminated magnetic layers: a first magnetic layer is a perpendicular magnetic film having a smaller domain wall coercive force than a third magnetic layer which is a superjacent layer, a second magnetic layer is a perpendicular magnetic film having a lower Curie temperature than the first and third magnetic layers, and the third magnetic layer is a perpendicular magnetic film having a relatively large domain wall coercive force and a relatively high Curie temperature.

In this medium, the temperature is raised up to a temperature near the Curie temperature of the second magnetic layer by the irradiation thereof with a light beam, whereby exchange bonding between the first and third magnetic layers is cut. In this way, domain walls in a boundary portion of a record mark are shifted by temperature gradient.

The magnetization reversal of the first magnetic layer, resulting from this domain wall shift, is detected as a magneto-optical signal change, so as to reproduce information.

It is desirable for this reproducing method that domain walls of the front boundary portion of a record mark and domain walls of the rear boundary portion of the record mark are independently formed in order to stabilize the shifting of the domain walls and improve the reproduction characteristics.

Thus, in order surely separate the domain walls, the following has been performed hitherto: after a magnetic film is formed, guide groove portions on both sides of a track are annealed with a high-power laser to degenerate or extinguish the magnetic film at side portions of the track, and subsequently a record mark is formed, thereby separating front and rear domain walls thereof from each other.

In order to separate domain walls at boundaries between lands and grooves, suggested is an optical memory element wherein a magnetic layer formed in side wall portions between the lands and the grooves is oxidized (see Japanese Unexamined Patent Publication No. 2000-235743).

In this element, after a magnetic layer is formed over the entire lands and grooves, a selective oxide layer made of Si is formed on the magnetic layer in the state that argon gas is introduced, and the resultant is kept in the atmosphere for a long time so that the magnetic layer formed on side wall is selectively oxidized.

(Problems to be Solved by the Invention)

However, in magneto-optical recording media described in known documents, it is necessary that after disks are formed, each of the disks is subjected to laser annealing treatment. Accordingly, the following problems arise: the process for producing the disks is complicated; the stability of the production is insufficient and the production cost increases since the laser annealing treatment is conducted. There is also caused a problem that this production process cannot be applied to a so-called land-groove substrate which can have a higher density.

Conventional optical memory elements require, in order to selectively oxidize a magnetic layer formed on side wall portions, to form a selective oxide layer which is unnecessary for the finished media and to allow the resultant to stand still in the atmosphere for a long time or to selectively oxidize the resultant with oxygen plasma. Therefore, the conventional memory elements have problems that the production process thereof is complicated and requires a long time, causing an increase in production cost.

### DISCLOSURE OF THE INVENTION

This invention provides a method for producing a magneto-optical recording medium, comprising: laminating three magnetic films having different compositions on a substrate via at least a heat radiating layer; forming a dielectric film of a predetermined film thickness on the resulting structure; nitriding the magnetic films in an area where no information is to be recorded; and laminating a material constituting the dielectric film on the resulting structure.

This invention also provides a method for producing a magneto-optical recording medium, comprising the steps of: laminating a first dielectric film, a heat radiating layer, and a second dielectric film in this order on a substrate; laminating a first magnetic film, a second magnetic film having a lower Curie temperature than the first magnetic film, and a third magnetic layer having a larger domain wall coercive force than the first magnetic film and a higher Curie temperature than the second magnetic film in this order on the second dielectric film; laminating a fourth dielectric film of a predetermined film thickness on the third magnetic film; nitriding at least the third magnetic film in an area where no information is to be recorded; and laminating a third dielectric film on the nitrided third magnetic film and the fourth dielectric film.

According to this invention, it is possible to easily produce a magneto-optical recording medium and to reduce the production cost thereof.

This invention also provides a magneto-optical recording medium comprising at least: a first magnetic film having a relatively small domain wall coercive force; a second magnetic film having a relatively low Curie temperature; and a third magnetic film having a relatively large domain wall coercive force and a high Curie temperature laminated in this order, wherein the third magnetic film present in an area where no information is to be recorded is selectively nitrided.

According to the invention, it is possible to stabilize the reproduction characteristics of a magneto-optical recording medium and to improve the CNR thereof.

### BRIEF DESCRIPTION OF THE DRAWINGS

FIG. 1 is a view illustrating the structure of a magneto-optical recording medium according to an embodiment of this invention;

FIGS. 2(a) to 2(c) are schematic sectional views of magneto-optical recording media according to embodiments of this invention;

FIGS. 3(a) to 3(d) are explanatory views of main production steps of the magneto-optical recording medium according to one of the embodiments of this invention;

FIG. 4 is a graph illustrating a relationship between the film thickness of a fourth dielectric film and the CNR of the magneto-optical recording medium of this invention when a land-groove substrate is used;

FIG. 5 is a graph illustrating a relationship between the film thickness of a fourth dielectric film and the CNR of the magneto-optical recording medium of this invention when a groove substrate is used;

FIG. 6 is a graph illustrating a relationship between the film thickness of a fourth dielectric film and the CNR of the magneto-optical recording medium of this invention when a land substrate is used; and

FIG. 7 is a view illustrating the structure of a conventional magneto-optical recording medium.

### BEST MODE FOR CARRYING OUT THE INVENTION

This invention is directed to easier production of a magneto-optical recording medium, reduction in production cost thereof, and improvement in CNR characteristics thereof by nitriding of a magnetic layer in an area where information does not need to be recorded.

In the magneto-optical recording medium production method of the invention, the above-mentioned nitriding step may be performed by allowing the medium after the formation of the fourth dielectric film to stand still in a nitrogen atmosphere at room temperature for a predetermined time.

As the substrate, there can be used a substrate having a surface having plural lands and grooves alternately formed thereon. In that case, adjacent land and groove may have a boundary defined by an inclined plane; the inclined plane may be an area where no information is to be recorded; and the fourth dielectric film may be laminated on the third magnetic film above the lands and grooves such that the fourth dielectric film is not laminated on the inclined plane.

When using a substrate having plural grooves formed on its surface as the above-mentioned substrate, adjacent grooves may have a boundary defined by side wall planes that form a protrusion; the side wall planes may be an area where no information is to be recorded; and the fourth dielectric film may be laminated on the third magnetic film above the grooves such that the fourth dielectric film is not laminated on the side wall planes.

When using a substrate having plural lands formed on its surface as the above-mentioned substrate, adjacent lands may have a boundary defined by side wall planes that form a recess; the side wall planes may be an area where no information is to be recorded; and the fourth dielectric film may be laminated on the third magnetic film above the lands such that the fourth dielectric film is not laminated on the side wall planes.

In this invention, the “domain wall coercive force” means force necessary for shifting magnetic walls formed in boundaries of magnetic domains in the magnetic film. For example, a material whose magnetic walls are harder to shift has a larger domain wall coercive force.

Each of the layers formed on the substrate can be formed by sputtering a target of each material arranged inside a sputtering apparatus with a sputtering gas.

Hereinafter, this invention is described in detail on the basis of embodiments illustrated in the drawings. It should be understood that this invention is not limited thereto. Structure of magneto-optical recording medium

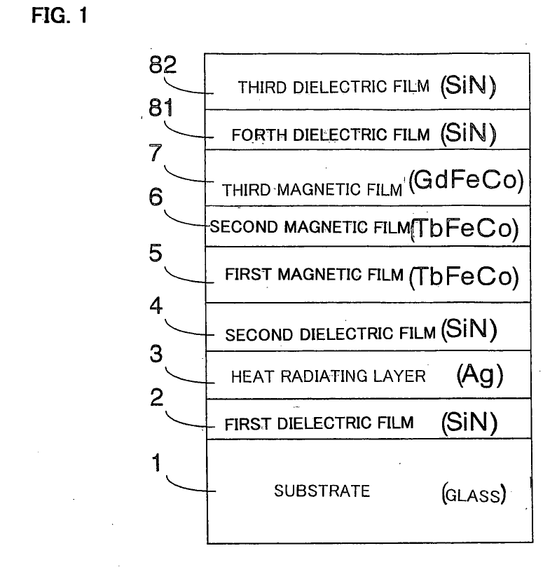

FIG. 1 illustrates a view of the structure of a magneto-optical recording medium according to an embodiment of this invention.

As illustrated in FIG. 1, a magneto-optical recording medium of the invention is a medium has a first dielectric film 2, a heat radiating layer 3, a second dielectric film 4, a first magnetic film 5, a second magnetic film 6, a third magnetic film 7, a fourth dielectric film 81 and a third dielectric film 82 formed in this order on a substrate 1.

The following describes an example of the film thickness and the material of each of the layers.
Substrate 1: 1.2 mm; glass
First dielectric film 2: 5 nm; SiN
Heat radiating layer 3: 30 nm; Ag
Second dielectric film 4: 30 nm; SiN
First magnetic film 5: 60 nm; Tb₂₇Fe₅₇Co₁₆
Second magnetic film 6: 10 nm; Tb₂₀Fe₇₉Co₁
Third magnetic film 7: 30 nm; Gd₂₇Fe₆₂Co₁₁
Fourth dielectric film 81: 2 nm; SiN
Third dielectric film 82: 53 nm; SiN

The material of each layer described above is only an example and other materials may be adopted upon necessity. The medium used in this embodiment is of type (front surface type) in which light is radiated onto the medium from the third dielectric film 82 side but not from the substrate side.

The structure of the medium of this invention can also be applied to a medium of commonly used type to which light is radiated from the substrate 1 side. In that case, the material and the film thickness of the first magnetic film 5 and those of the third magnetic film 7 are inversed.

In the front surface medium to which light is radiated from the third dielectric film side, light reaches the magnetic films without penetrating the thick substrate, whereby an object lens can be made small and the density of the medium can be made higher than that of the medium to which light is radiated from the substrate side.

Besides glass, a material for HDD (Hard Disk Drive) such as Al alloy or Si may be used as the substrate 1 of the invention.

The first dielectric film 2 may be of C, SiO₂, Y—SiO₂, AlN or the like.

As the second dielectric film 4, C or an oxide or nitride such as SiO₂, Y—SiO₂, ZnSiO₂, AlO or AlN may be used.

As the third and fourth dielectric films 81, 82, an oxide or nitride such as SiO₂, ZnSiO₂, AlO or AlN may be used.

As the heat radiating layer 3, an Al alloy such as AlTi or AlCr, Ag, Au, Pt, an alloy made mainly of these metals, or the like may be used.

As the first magnetic film 5, a rare earth-transition metal such as DyFeCo or TbDyFeCo may be used in addition to TbFeCo.

As the second magnetic film 6, a rare earth-transition metal such as DyFeCo or TbDyFeCo may be used in addition to TbFeCo.

As the third magnetic film 7, a rare earth-transition metal such as GdFeCoAl, GdTbFeCo or GdDyFeCo may be used in addition to GdFeCo.

The material and composition of the first magnetic film 5 are selected to have a higher domain wall coercive force than that of the third magnetic film 7.

The material and composition of the second magnetic film 6 are selected to have a lower Curie temperature than those of the first and third magnetic films (5, 7).

The material and composition of the third magnetic film 7 are selected to have a lower domain wall coercive force and a higher Curie temperature than those of the first and second magnetic films (5, 6).

In FIG. 1, the third and fourth dielectric films (81, 82) are both made of SiN, and are different only in film thickness.

However, the third dielectric film 82 is formed after the relatively thin fourth dielectric film 81 is formed and the films from the first to third magnetic films (5, 6, 1) are subjected to nitriding treatment as will be described later. The third and fourth dielectric films are not formed at a time because when a dielectric film as thick as about 55 nm is formed on a magnetic film, the subjacent magnetic film cannot be sufficiently nitrided.

The film thickness of the fourth dielectric film 81 is made into such a thickness that the film is not formed in an area where no information is to be recorded and the magnetic layers in an area where information is to be recorded are not nitrided while the CNR of the area where information is to be recorded is sufficiently kept. It is therefore preferable to set the film thickness of the fourth dielectric film 81 within the range of 1 to 10 nm.

For enhancement, the film thicknesses of the fourth dielectric film 81 and the third dielectric film 82 may be adjusted so that the total film thickness of the two dielectric films is about 55 nm. Further, adjusting the total film thickness can control the optical and thermal conditions.

The magneto-optical recording medium of the invention illustrated in FIG. 1 can adopt any one of (a) a land-groove substrate, (b) a groove substrate and (c) a land substrate. Though conventional media can not use the land-groove substrate (a) because laser annealing removes a magnetic layer on lands or grooves, the present invention can use the land-groove substrate (a) and therefore, a magneto-optical recording medium having a high density can be provided.

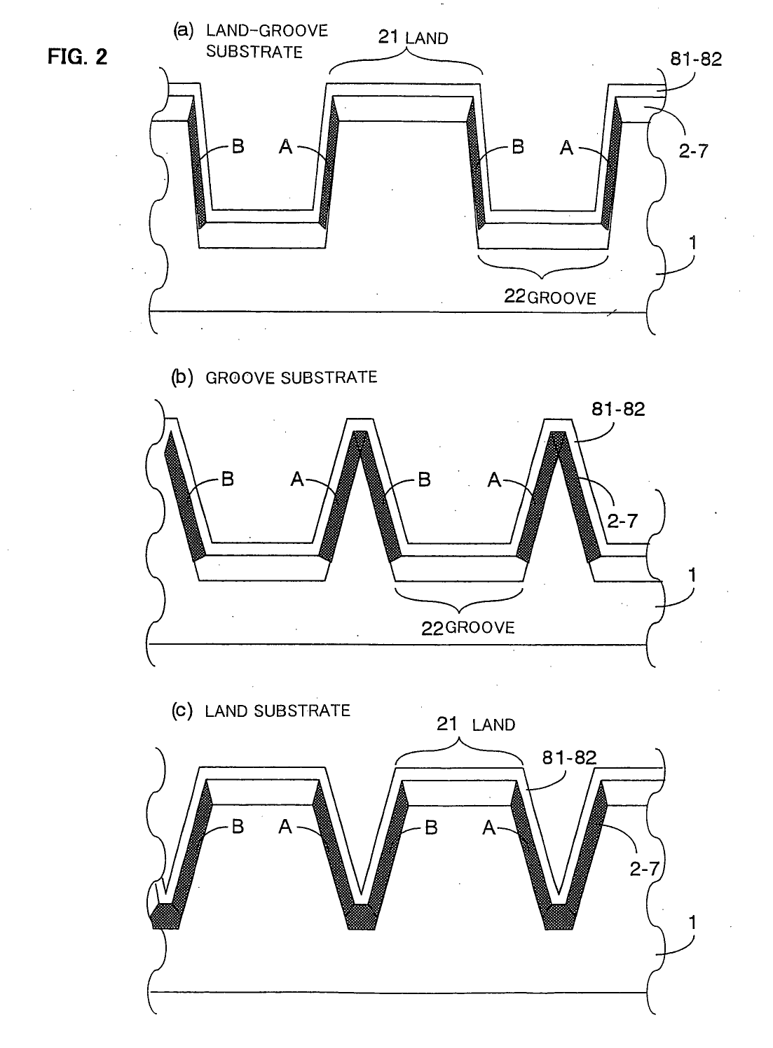

FIGS. 2(a) to 2(c) illustrate schematic sectional views of magneto-optical recording media formed on three different substrates according to embodiments of the invention.

In the figures, the films from the first dielectric film 2 to the third magnetic films 7 illustrated in FIG. 1 are not separately illustrated. However, the layers are actually formed.

Though the fourth and third dielectric films (81, 82) are formed on the third magnetic layer 7, but figures are not drawn to scale.

FIG. 2(a) illustrates a land-groove substrate. Flat portions of land 21 and grooves 22 are areas where information is to be recorded. Information is recorded and reproduced in the magnetic films (5, 6, 7) formed on the land 21 and the grooves 22 in these areas.

The magnetic films (5, 6, 7) in boundaries between the lands 21 and the grooves 22, that is, areas A and areas B defined by inclined planes illustrated in FIG. 2(a) which are nitrided serve as areas where no information is to be recorded or reproduced. Since the areas A and B where no information is to be recorded or reproduced are nitrided, information-recording areas of the lands 21 and the grooves 22 are magnetically isolated so that the reliability at the time of reproducing information can be improved.

FIG. 2(b) illustrates a groove substrate. The magnetic films in areas A and B which are formed on side walls of the substrate surface that form protrusions are nitrided, thereby magnetically separating flat portions of adjacent grooves 22 from each other.

In FIG. 2(b), flat portions (track pitch: about 0.4 μm) of the grooves 22 serve as areas where information is to be recorded. The side walls forming the protrusions are not used as recording areas but are used for servo tracking.

FIG. 2(c) illustrates a land substrate. The magnetic films (5, 6, 7) in areas A and B which are formed on side walls that form recesses are nitrided, thereby magnetically separating flat portions of adjacent lands 21 from each other.

In FIG. 2(c), the flat portions (track pitch: about 0.4 μm) of the land 21 serve as areas where information is to be recorded. The side walls forming the recesses are not used as recording areas but are used for servo tracking.

Method for Producing Magneto-Optical Recording Medium

The following describes a method for forming each of the layers of the medium according to one of the embodiments of this invention.

First, a substrate 1, which has any one of the surface configuration illustrated in FIGS. 2(a) to 2(c), is produced. The substrate 1 can be formed by use of a metal or a plastic such as PC (polycarbonate).

Next, the substrate 1 is set in a predetermined position inside a DC magnetron sputtering apparatus in order to form each of the layers (2 to 82) illustrated in FIG. 1 on the substrate.

Targets necessary for forming the respective layers are arranged at a position opposed to the substrate 1, and reactive sputtering is performed in turn in the atmosphere of a reactive gas such as Ar gas.

The reactive sputtering is performed by setting the substrate 1 on a table rotating near each of the targets while revolving on its axis, or by rotating each of the targets while fixing the substrate. The reactive sputtering is performed at room temperature.

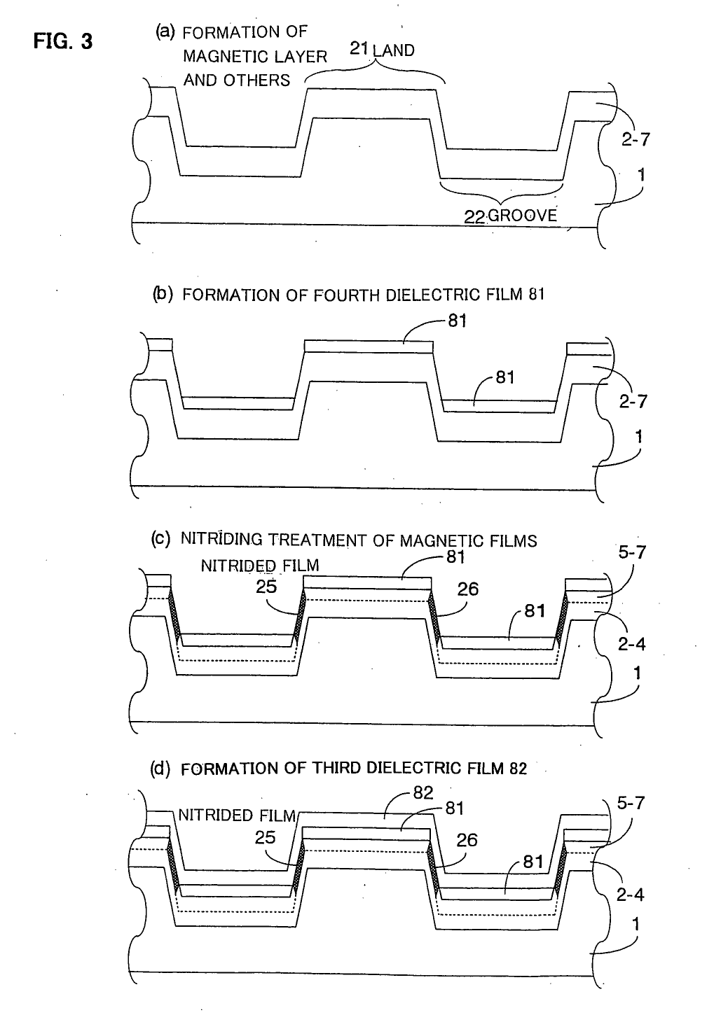

FIGS. 3(a) to 3(d) illustrate main steps of the process for forming the magneto-optical recording medium of the first embodiment of this invention.

FIGS. 3(a) to 3(d) illustrate sectional views of the structure of the medium when a land-groove substrate is used. The order and conditions of the formation steps are the same even when a groove or land substrate is used. Since the surface configurations of the land and groove substrates differ from that of the land-groove substrate, the structures of laminated layers are different, but areas to be nitrided are areas where no information is to be recorded in all of the cases.

The formation of the respective layers according to the first embodiment is performed in the following order.

Step 1: Formation of First Dielectric Film 2

Target: Si
Sputtering gas: Ar gas, and N₂ gas
Flow quality ratio: Ar: N_{2=2:1}
Gas pressure: 0.3 Pa
Applied electric power: 0.5 kw

Under the above-mentioned conditions, SiN is formed as the first dielectric film 2 on the substrate 1 to have a film thickness of about 5 nm.

STEP 2: Formation of Heat Radiating Layer 3

Target: Ag
Sputtering gas: Ar gas
Gas pressure: 0.1 Pa
Applied electric power: 0.5 kw

Under the above-mentioned conditions, a Ag film is formed as the heat radiating layer 3 on the first dielectric film 2 to have a film thickness of about 30 nm.

Step 3: Formation of Second Dielectric Film 4

Target: Si
Sputtering gas: Ar gas and N₂ gas
Flow quality ratio: Ar: N₂=2:1
Gas pressure: 0.3 Pa
Applied electric power: 0.5 kw

Under the above-mentioned conditions, SiN is formed as the second dielectric film 4 on the heat radiating layer 3 to have a film thickness of about 30 nm.

Step 4: Formation of First Magnetic Film 5

Target: alloy target of Tb₂₇Fe₅₇Co₁₆
Sputtering gas: Ar gas
Gas pressure: 0.5 Pa
Applied electric power: 0.5 kw

Under the above-mentioned conditions, Tb₂₇Fe₅₇Co₁₆ is formed as the first magnetic film 5 on the second dielectric film 4 to have a film thickness of about 60 nm. The first magnetic film 5 has a Curie temperature of 260 degrees which is higher than that of the subsequently formed second magnetic film 6.

Step 5: Formation of Second Magnetic Film 6

Target: alloy target of Tb₂₀Fe₇₉Co₁
Sputtering gas: Ar gas
Gas pressure: 0.5 Pa
Applied electric power: 0.5 kw

Under the above-mentioned conditions, Tb₂₀Fe₇₉Co₁ is formed as the second magnetic film 6 on the first magnetic film 5 to have a film thickness of about 10 nm. The second magnetic film 6 has a Curie temperature of about 130 degrees which is lower than those of the first and third magnetic films (5, 7).

Step 6: Formation of Third Magnetic Film 7

Target: alloy target of Gd₂₇Fe₆₂Co₁₁
Sputtering gas: Ar gas
Gas pressure: 0.5 Pa
Applied electric power: 0.5 kw

Under the above-mentioned conditions, Gd₂₇Fe₆₂Coll is formed as the third magnetic film 7 on the second magnetic film 6 to have a film thickness of about 30 nm. The third magnetic film 7 has a Curie temperature of 240 degrees which is higher than that of the second magnetic film 6.

The composition ratios of the first, second and third magnetic films are not limited to the above, and the composition ratio of each magnetic layer can be selected in such a manner that the Curie temperatures of the first and third magnetic layers (5, 7) are higher than that of the second magnetic film 6 and the films are of domain wall shift type.

FIG. 3(a) illustrates a schematic sectional view of the medium after the formation of the films from the first dielectric film 2 to the third magnetic film. The magnetic films (5, 6, 7) are formed on the boundaries between the lands and the grooves, that is, portions where no information is to be recorded. Since the boundaries are defined by inclined planes, the magnetic films are formed to have a smaller film thickness than that formed on the flat portions of the land 21 and grooves 22 where information is to be recorded.

The film thickness of the magnetic films and the like becoming smaller on the inclined planes is probably because of the directivity of sputtering particles at the reactive sputtering. In general, a magnetron sputtering apparatus is designed to vertically sputter sputtering particles from above the substrate to the substrate in order to uniformly form a film on a flat portion of a substrate. In other words, with a sputtering apparatus having a strong directivity to the perpendicular direction, only a small number of particles fly in an oblique direction, the direction in which many particles can adhere to the inclined planes, and thus, the thickness of the film formed on the inclined planes becomes thin.

Step 7: Formation of Fourth Dielectric Film 81

Target: Si
Sputtering gas: Ar gas and N₂ gas
Flow quality ratio: Ar: N₂=2:1
Gas pressure: 0.3 Pa
Applied electric power: 0.5 kw

Under the above-mentioned conditions, SiN is formed as the fourth dielectric film 81 on the third magnetic film 7 to have a film thickness of about 2 nm. The film thickness of the fourth dielectric film 81 needs to be selected so that the magnetic films (5, 6, 7) in the portions which are not recording areas are sufficiently nitrided to such an extent that adjacent recording areas are magnetically separated from each other in the subsequent nitriding treatment. Thus, the film thickness is not limited to 2 nm.

The fourth dielectric film 81 is also laminated to some extent on the inclined planes at the boundaries. The film formed on the inclined planes has a relatively smaller thickness than that formed on the flat portions of the lands and grooves because of the perpendicular directivity of the sputtering apparatus discussed above.

When forming the fourth dielectric film 81, sputtering particles which form the fourth dielectric film 81 can be controlled to not adhere substantially onto the inclined planes by controlling the perpendicular directivity of the sputtering particles and optimizing the inclination angle of the substrate.

FIG. 3(b) illustrates a sectional view of the medium after the formation of the fourth dielectric film 81. As illustrated in the figure, the fourth dielectric film 81 is formed on the flat portions of the lands 21 and the grooves 22 as in the case of the other layers (2 to 7). However, the film 81 can be formed so as to be not substantially formed on the boundaries (inclined planes) between the lands and grooves. For this reason, the magnetic films on the boundaries where the fourth dielectric film 81 is not formed, that is, the magnetic films on the inclined planes are nitrided in nitriding treatment of the subsequent step 8.

As will be described later, in order to maintain a CNR equal to or higher than that of conventional magneto-optical recording media, it is preferable to set the film thickness of the fourth dielectric film 81 to about several nanometers (1 to 10 nm). In particular, where a land-groove substrate is used, for example, the film thickness of the fourth dielectric film 81 is preferably about 2 to 5 nm in order to obtain a CNR of 45 dB or higher.

Step 8: Nitriding Treatment of Magnetic Films

The medium after the step 7 is subjected to nitriding treatment by introducing N₂ gas having a gas pressure of 1.0 Pa into a sputtering apparatus and allowing the medium to stand still therein at room temperature for about 5 minutes.

The respective magnetic films (5, 6, 7) are laminated on both the flat portions and boundaries of, for example, the land-groove substrate. On the boundaries, however, the film thickness of each magnetic film is smaller than that formed on the flat portions since the boundaries are constituted of inclined planes. The fourth dielectric film is not laminated on the boundaries. Consequently, the magnetic films on the boundaries (the areas A and B in FIGS. 2(a) to 2(c)), which have a small film thickness, are nitrided.

If the medium is exposed to the atmosphere of N₂ for a very long time, nitriding of the recording area, where nitriding is not desired, also advances.

Thus, it is preferable to allow the medium to stand still for at longest a time when only the following are nitrided: the boundaries (inclined planes) between the lands and grooves of the land-groove substrate, the side wall planes forming protrusions of the groove substrate, or the side wall planes forming recesses of the land substrate. Accordingly, the time for leaving the medium standing is not limited to 5 minutes.

FIG. 3(c) illustrates a sectional view of the medium after being subjected to the nitriding treatment. With this nitriding treatment, the magnetic films (5, 6, 7) located on the boundaries between the lands 21 and the grooves 22 are nitrided, and nitrided films 25 and 26 are formed.

Since the magnetic properties are destroyed in the nitrided films 25 and 26, information can not be recorded therein. Consequently, the magnetic films (5, 6, 7) on the flat portions of the adjacent lands 21 and the grooves 22 are magnetically isolated by the nitrided films 25 and 26.

Though the magnetic films are composed of the three layers (5, 6, 7), it is sufficient to nitride at least the third magnetic film 7 in order to magnetically separate the magnetic films in adjacent recording areas. Therefore, the appropriate time for allowing the medium to stand still may be selected considering the film thicknesses of the laminated magnetic films (5, 6, 7) and the fourth dielectric film 81, recording characteristics required, and the like.

Step 9: Formation of Third Dielectric Film 82

Target: Si
Sputtering gas: Ar gas and N₂ gas
Flow quality ratio: Ar: N_{2=2:1}
Gas pressure: 0.3 Pa
Applied electric power: 0.5 kw

Under the above-mentioned conditions, SiN is formed as the third dielectric film 82 on the fourth dielectric film 81 to have a film thickness of about 53 nm. The film thickness of the third dielectric film 82 is not limited to 53 nm and may be set in such a manner that the total thickness of the film 82 and the fourth dielectric film 81 is about 55 nm.

Where the fourth dielectric film 81 is formed to have a thickness of 1 to 10 nm, the third dielectric film 82 may be formed to have a thickness of about 54 to 45 nm.

Through the steps 1 to 9, the magneto-optical recording medium of this invention as illustrated in FIG. 3(d) is completed.

These production steps do not include any laser annealing step as in the prior art, and all the steps except the nitriding treatment involve reactive sputtering performed at room temperature. Therefore, the production steps can be smoothly proceed, allowing a reduction in production cost. Further, the reproduction characteristics do not deteriorate afterwards as in the case of oxidizing treatment, whereby stable reproduction can be achieved.

Reproduction Characteristics of Magneto-Optical Recording Media

The following describes the reproduction characteristics of the magneto-optical recording media of this invention.

In order to examine the reproduction characteristics, the following evaluations were carried out.
Evaluation device: spectrum analyzer
Optical system: object lens NA=0.85, and wavelength=405 nm
Recording: laser strobe magnetic field modulation recording system
   Recording frequency=50 MHz (=0.15 μm)
Evaluation value: CNR (signal-to-noise ratio (dB))

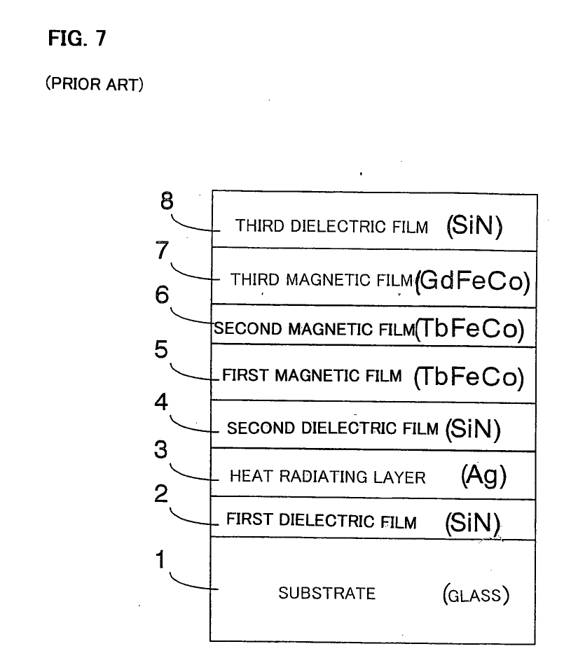

For comparison, conventional media, as illustrated in FIG. 7, were formed, ones of which having magnetic films in areas where no information was to be recorded annealed with a laser after a third magnetic film 7 was formed, and the others of which having a third dielectric film 8 formed without any laser annealing.

For the laser annealed conventional media, a groove substrate and a land substrate were respectively used. For the conventional media which were not laser annealed, three kinds of substrates including a land-groove substrate were respectively used.

In the conventional media, films from a first dielectric film 2 to the third dielectric film 7 were formed on a substrate 1 to have the same film thicknesses as described in the step 1 to step 6 of the inventive production steps, under the same conditions as described therein. The third dielectric film 8 was formed to have a film thickness of 53 nm under the same conditions as in the step 9.

Laser annealing was performed by radiating a high power laser onto the areas where no information was to be recorded of the third magnetic layer 7 before the formation of the third dielectric film 8.

In order to check the effect of the nitriding treatment, there were prepared the inventive media which were nitrided for a fixed period of 5 minutes and in which the thickness of fourth dielectric films 81 was changed from 1 nm to 10 nm in increments of 1 nm.

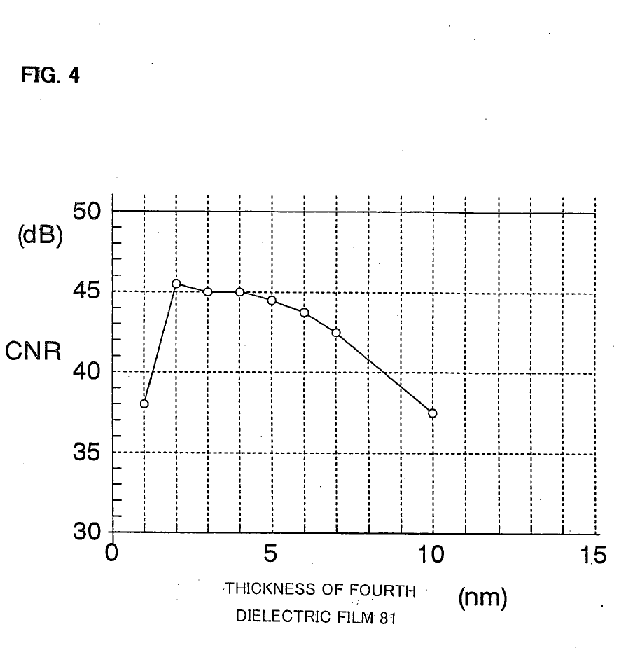

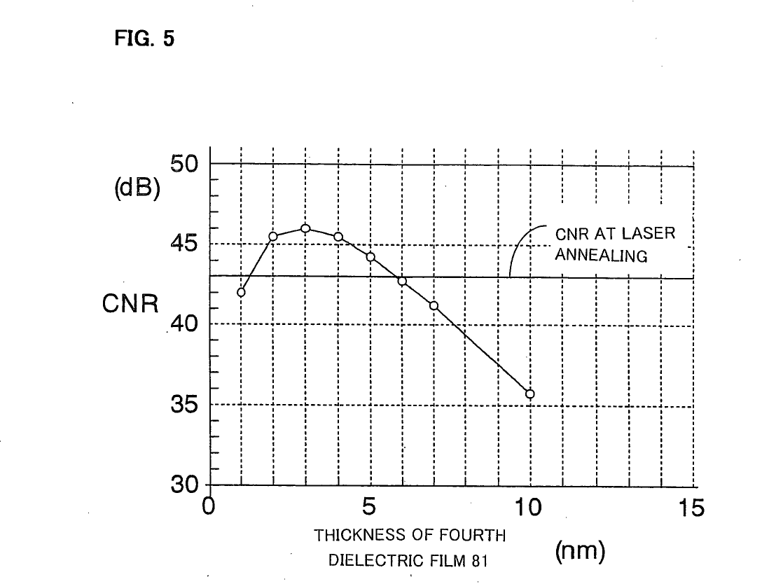

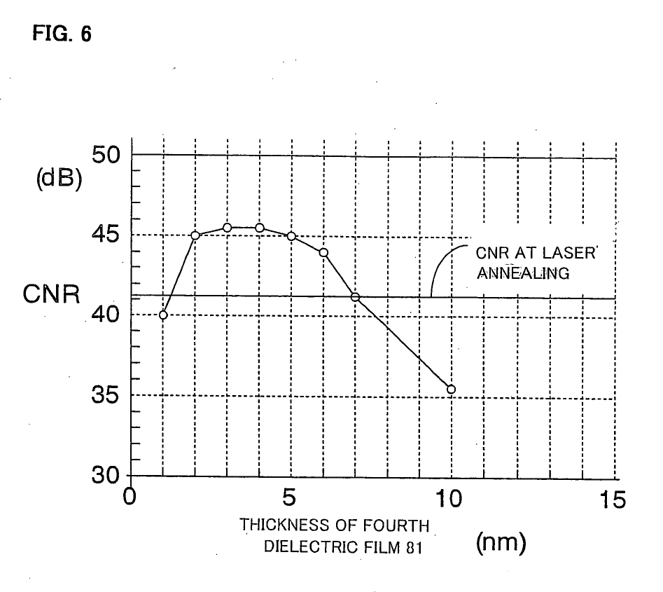

FIG. 4 shows the CNR (dB) at reproduction of the medium of this invention using the land-groove substrate. FIG. 5 shows the CNR (dB) of the inventive medium using the groove substrate. FIG. 6 shows the CNR (dB) of the inventive medium using the land substrate. In each of the figures, the horizontal axis indicates the film thickness (nm) of the fourth dielectric film 81.

(a) Reproduction Characteristics of Land-Groove Substrates

In the conventional medium using the land-groove substrate which was not laser annealed, magnetic domains were not enlarged at the time of reproduction and the reproduction was poor since domain walls were not separated.

The inventive media having 1 nm- and 10 nm-thick fourth dielectric films 81, respectively, as shown in FIG. 4, showed CNRs of about 37 dB which was somewhat bad. However, when the thickeness of the fourth dielectric film 81 was within the range of 2 to 7 nm, the CNR was within the range of 42 to 46 dB, showing the values suitable for practical use.

In particular, when the film thickness of the fourth dielectric film 81 was set to 2 nm, the CNR was 45.5 dB. Thus, magnetic domains were sufficiently enlarged and the effect of nitriding was the largest.

When the film thickness of the fourth dielectric film 81 is about 1 nm or less, there is a high possibility that the flat portions of the lands and grooves, which are recording areas, are also nitrided, resulting in a decrease in CNR.

When the film thickness is 10 nm or more, it is believed that the fourth dielectric film 81 is also laminated on the inclined planes serving as the boundaries between the lands and the grooves. Insufficient nitriding of the boundaries causes incomplete separation of the magnetic films, which is why a decline in CNR is caused.

In the case of land-groove substrates, magnetic domains can be stably enlarged at the time of reproduction and a practically fine CNR can be achieved by setting the film thickness of the fourth dielectric film 81 to an appropriate value in the range of 2 to 7 nm.

(b) Reproduction Characteristics of Groove Substrates

In the conventional medium using the groove substrate which was not laser annealed, magnetic domains were not enlarged at the time of reproduction, and reproduction was poor.

In the laser annealed conventional medium, reproduction on the basis of the enlargement of magnetic domains was possible. The CNR was 43.0 dB.

On the other hand, the inventive media exhibited a higher CNR than the CNR of the conventional media when the film thickness of the fourth dielectric film 81 was in the range of 2 to 5 nm, as shown in FIG. 5. In particular, according to FIG. 5, the CNR was 46.0 dB and the effect of the nitriding was the largest when the film thickness was 3 nm.

In the case of groove substrate, magnetic domains can stably be enlarged at the time of reproduction and a practically fine CNR can be achieved by appropriately selecting the film thickness of the fourth dielectric film 81 of the inventive medium.

(c) Reproduction Characteristics of Land Substrates

In the conventional medium using the land substrate which was not laser annealed, magnetic domains were not enlarged at the time of reproduction, and reproduction was poor.

In the laser annealed conventional medium, reproducing on the basis of the enlargement of magnetic domains was possible. The CNR was 42.5 dB.

On the other hand, the inventive media achieved a higher CNR than the CNR of the conventional media when the film thickness of the fourth dielectric film 81 was in the range of 2 to 6 nm, as shown in FIG. 6. In particular, according to FIG. 6, the CNR was 45.5 dB and the effect of nitriding was the largest when the film thickness was 3 nm.

In the case of land substrate, magnetic domains can stably be enlarged at the time of reproduction and a practically fine CNR can be achieved by appropriately selecting the film thickness of the fourth dielectric film.

As described above, in the magneto-optical recording medium of this invention, a dielectric film having a predetermined film thickness is formed on laminated magnetic films and subsequently the magnetic films in portions where no information is to be recorded are nitrided; therefore, the medium has a stable reproduction characteristics, and a practically good CNR can be obtained.

Since it is unnecessary to perform a laser annealing step as in the case of conventional media, the production steps can be made easier and the production cost can be reduced. Since domain walls are separated by the nitriding treatment, it is possible to provide a magneto-optical recording medium having stable reproduction characteristics that does not deteriorate. Furthermore, the medium having a lamination structure of this invention can be adapted to a land-groove substrate, and the production cost of a high-density medium can be reduced and the reproduction characteristics thereof can be improved.

1. A method for producing a magneto-optical recording medium, comprising
laminating three magnetic films having different compositions on a substrate via at least a heat radiating layer,
forming a dielectric film of a predetermined film thickness on the resulting structure,
nitriding the magnetic films in an area where no information is to be recorded and
laminating a material constituting the dielectric film on the resulting structure.

2. A method for producing a magneto-optical recording medium comprising the steps of
laminating a first dielectric film, a heat radiating layer, and a second dielectric film in this order on a substrate,
laminating a first magnetic film, a second magnetic film having a lower Curie temperature than the first magnetic film, and a third magnetic layer having a larger domain wall coercive force than the first magnetic film and a higher Curie temperature than the second magnetic film in this order on the second dielectric film,
laminating a fourth dielectric film of a predetermined film thickness on the third magnetic film
nitriding at least the third magnetic film in an area where no information is to be recorded and
laminating a third dielectric film on the nitrided third magnetic film and the fourth dielectric film.

3. The method for producing a magneto-optical recording medium according to claim 2, wherein the nitriding step is conducted by allowing the medium after the lamination of the forth dielectric film to stand still in a nitrogen atmosphere at room temperature for a predetermined time.

4. The method for producing a magneto-optical recording medium according to claim 1, 2 or 3, wherein the substrate is a substrate having plural lands and grooves alternately formed on its surface, adjacent land and groove having a boundary defined by an inclined plane, the inclined plane being the area where no information is to be recorded,
and the fourth dielectric film is laminated on the third magnetic film above the lands and grooves such that the fourth dielectric film is not laminated on the inclined plane.

5. The method for producing a magneto-optical recording medium according to claim 1, 2 or 3, wherein the substrate is a substrate having plural grooves formed on its surface, adjacent grooves having a boundary defined by side wall planes that form a protrusion, the side wall planes being the area where no information is to be recorded,
and the fourth dielectric film is laminated on the third magnetic film above the grooves such that the fourth dielectric film is not laminated on the side wall planes.

6. The method for producing a magneto-optical recording medium according to claim 1, 2 or 3, wherein the substrate is a substrate having plural lands formed on its surface, adjacent lands having a boundary defined by side wall planes that form a recess wall planes, the side being the area where no information is to be recorded,
and the fourth dielectric film is laminated on the third magnetic film above the lands to such that the fourth dielectric film is not laminated on the side wall planes.

7. A magneto-optical recording medium comprising at least a first magnetic film having a relatively small domain wall coercive force, a second magnetic film having a relatively low Curie temperature, and a third magnetic film having a relatively large domain wall coercive force and a high Curie temperature laminated in this order,
wherein the third magnetic film present in an area where no information is to be recorded is selectively nitrided.

8. The magneto-optical recording medium according to claim 7, wherein plural lands and grooves are alternately formed in an area where information is to be recorded, adjacent lands and grooves having a boundary defined by an inclined plane, the inclined plane being the area where no information is to be recorded.

9. The magneto-optical recording medium according to claim 7, wherein plural grooves are formed in an area where information is to be recorded, adjacent grooves having a boundary defined by side wall planes that form a protrusion, the side wall planes being the area where no information is to be recorded.

10. The magneto-optical recording medium according to claim 7, wherein plural lands are formed in an area where information is to be recorded, adjacent lands having a boundary defined by side wall planes that form a recess, the side wall planes being the area where no information is to be recorded.
